(19) United States
(12) Patent Application Publication
(10) Pub. No.: US 2015/0286897 A1
(43) Pub. Date: Oct. 8, 2015

(54) AUTOMATED TECHNIQUES FOR PHOTO UPLOAD AND SELECTION

(71) Applicant: MICROSOFT CORPORATION, REDMOND, WA (US)

(72) Inventor: John Spaith, Bellevue, WA (US)

(73) Assignee: MICROSOFT CORPORATION, REDMOND, WA (US)

(21) Appl. No.: 14/244,489

(22) Filed: Apr. 3, 2014

(51) Int. Cl. G06K 9/62; G06K 9/00; H04N 5/44; G06K 9/46; G06F 17/30

(52) U.S. Cl. CPC G06K 9/6267; G06K 9/4652; G06F 17/3028; H04N 5/44; G06K 9/00268; G06K 9/4661

(57) ABSTRACT

Methods, systems, and computer program products are provided that determine the merit of a given captured image, and apply an intelligent policy to the uploading of the image. An image may be captured by an image capturing device of a user. A merit score is determined for the captured image. The merit score indicates a predicted value of the captured image to the user. An access policy is assigned to the captured image based on the determined merit score. Access to the captured image is enabled based on the assigned access policy. For instance, the captured image may be deleted, may be automatically uploaded to a server over a fee-free network connection only, may be uploaded to the server over any available network connection, may be uploaded at a reduced image resolution, and/or may be uploaded at full image resolution, depending on the access policy.

### BACKGROUND

Cameras are devices that are used to capture images (also referred to as “pictures,” “photos,” “photographs,” or “snapshots”). Cameras are becoming more prevalent, and are carried by persons more often than ever before. Such cameras include traditional, standalone cameras, and cameras that are embedded in multipurpose devices such as smartphones. Cameras are increasingly used that can be configured to automatically publish pictures to the Internet. For example, such cameras may enable captured images to be automatically uploaded to Internet-based social networks such as Facebook® operated by Facebook, Inc. of Palo Alto, Calif., or Google+ operated by Google, Inc. of Mountain View, Calif., to cloud-based storage sites such as OneDrive™ provided by Microsoft Corp. of Redmond, Wash., or to other network-based sites. In this manner, user effort in manually uploading images may be saved.

To configure automatic image uploading, a user may select what network to upload pictures over, may select whether to allow the pictures to be uploaded automatically, may configure how to store them in a back end server, and may configure how to automatically render pictures (e.g., using a Microsoft Windows® Live Tile photo display, etc.), among other configuration options. However, not all pictures captured by a user may be desired to be automatically uploaded to a site. Such undesired automatic uploading can lead to a “pocket shot” (e.g., a photograph that is all black because it was inadvertently taken in a pocket of a user) being uploaded over a paid data network and displayed to users with the same priority as a more valuable family snapshot. The user probably would not consciously make the decision to upload a pocket shot if the user was manually configuring the upload policy for their captured images.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, and computer program products are provided that determine the merit of a given captured image, and apply an intelligent policy to the uploading, downloading, and/or display of the image.

For instance, in one implementation, a method is provided. A merit score is determined for a captured image. The merit score indicates a predicted value of the captured image to a user having an image capturing device used to capture the image. An access policy is assigned to the captured image based on the determined merit score. Access to the captured image is enabled based on the assigned access policy.

In one aspect, the merit score can be determined by one or more of determining a color uniformity of the captured image, determining a focus quality of the captured image, determining an amount of light indicated in the captured image, determining a human face present in the captured image, or determining that an object included in a library of objects is present in the captured image.

In a further aspect, the assigning of an access policy to the captured image may include one or more of designating the captured image for deletion, designating the captured image for upload to a back end server over a fee-free network connection, designating the captured image for upload to the back end server over any available network connection, or designating the captured image for upload to the back end server at a reduced image resolution.

In another implementation, a user device is provided that includes a merit determiner, policy logic, scheduling logic, and an image uploader. The merit determiner is configured to determine a merit score for an image captured by the user device due to interaction of a user. The merit score indicates a predicted value of the captured image to the user. The policy logic is configured to assign an access policy to the captured image based on the determined merit score. The scheduling logic is configured to determine instances at which to upload captured images from the user device to a back end server. The image uploader is configured to enable the captured image to be uploaded to the back end server based on the assigned access policy and as enabled by the scheduling logic.

In still another implementation, a server is provided that includes an image communication interface, a merit determiner, and policy logic. The image communication interface is configured to receive captured images from user devices, and to store the received captured images. The merit determiner is configured to determine a merit score for a captured image of the stored captured images. The merit score indicates a predicted value of the captured image to a user associated with the user device from which the captured image was received. The policy logic is configured to assign an access policy to the captured image based at least on the determined merit score. The image communication interface is configured to enable the captured image to be downloaded to a rendering device based on the assigned usage.

The merit determiner of the server may be configured to determine the merit score for a captured image based on a merit score previously determined for the captured image and received with the captured image from the user device, or may determine the merit score independently.

A computer readable storage medium is also disclosed herein having computer program instructions stored therein that determine the merit of a given captured image, and apply an intelligent policy to the uploading, downloading, and/or display of the image, according to the embodiments described herein.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows a block diagram of a system in which a user device, a back end server, and a rendering device communicate to determine a merit score and an access policy for an image captured by the user device, according to an example embodiment.

FIG. 2 shows a flowchart providing a process for enabling access to a captured image, according to an example embodiment.

FIG. 3 shows a block diagram of an example of the system of FIG. 1, according to an example embodiment.

FIG. 4 shows a flowchart providing a process in a user device to determine a merit score and an access policy for an image captured by the user device, according to an example embodiment.

FIG. 5 shows a flowchart providing a process in a server to determine a merit score and an access policy for an image captured by a user device, according to an example embodiment.

FIG. 6 shows a flowchart providing a process in a rendering device to render an image captured by a user device based on an access policy determined for the image, according to an example embodiment.

FIG. 7 shows a flowchart providing a process for determining a merit score for a captured image, according to an example embodiment.

FIGS. 8A-8D shows processes for determining an access policy for a captured image, according to example embodiments.

FIG. 9 shows a block diagram of an exemplary user device in which embodiments may be implemented.

FIG. 10 shows a block diagram of an example computing device that may be used to implement embodiments.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification and accompanying drawings disclose one or more embodiments that incorporate the features of the present invention. The scope of the present invention is not limited to the disclosed embodiments. The disclosed embodiments merely exemplify the present invention, and modified versions of the disclosed embodiments are also encompassed by the present invention. Embodiments of the present invention are defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Exemplary Embodiments

Embodiments described herein enable the “merit” of a captured image (e.g., a “picture,” “photo,” “photograph,” or “snapshot”) to be determined based on an algorithm that may execute on the device that captured the image, on a server, and/or on a device that renders (displays) the image. An access policy or rule for providing access to the image may be selected based on the determined “merit” of the image.

For instance, FIG. 1 shows a block diagram of a system 100, according to an example embodiment. System 100 includes a user device 102, a back end server 104, and a rendering device 106. In system 100, user device 102, back end server 104, and rendering device 106 communicate to determine a merit score and an access policy for an image 122 that is received (in the form of light) and captured by user device 102. Although user device 102 and rendering device 106 are shown as separate devices in FIG. 1, in some embodiments, user device 102 and rendering device 106 may be the same user device. In another embodiment, back end server 104 may not be present, and user device 102 and rendering device 106 may be separate devices that communicate directly with each other. The features of system 100 are described as follows.

User device 102 and rendering device 106 may be any type of stationary or mobile computing device, including a mobile computer or mobile computing device (e.g., a Microsoft® Surface® device, a personal digital assistant (PDA), a laptop computer, a notebook computer, a tablet computer such as an Apple iPad™, a netbook, etc.), a mobile phone (e.g., a cell phone, a smart phone such as a Microsoft Windows® phone, an Apple iPhone, a phone implementing the Google® Android™ operating system, a Palm® device, a Blackberry® device, etc.), a wearable computing device (e.g., a smart watch, a head-mounted device including smart glasses such as Google® Glass™, etc.), a digital camera, or other type of mobile device, or a stationary computing device such as a desktop computer or PC (personal computer). Server 104 may be any type of computing device, mobile or stationary, that is configured to operate as an image server.

Each of user device 102, server 104, and rendering device 106 may include a network interface that enables user device 102, server 104, and rendering device 106 to communicate over one or more networks. Example networks include a local area network (LAN), a wide area network (WAN), a personal area network (PAN), and/or a combination of communication networks, such as the Internet. The network interfaces may each include one or more of any type of network interface (e.g., network interface card (NIC)), wired or wireless, such as an as IEEE 802.11 wireless LAN (WLAN) wireless interface, a Worldwide Interoperability for Microwave Access (Wi-MAX) interface, an Ethernet interface, a Universal Serial Bus (USB) interface, a cellular network interface, a Bluetooth™ interface, a near field communication (NFC) interface, etc.

As shown in FIG. 1, user device 102 includes a merit determiner 108 and policy logic 110, back end server 104 includes a merit determiner 112 and policy logic 114, and rendering device 106 includes policy logic 116. Although not shown in FIG. 1, rendering device 106 may include a merit determiner Merit determiners 108 and 112 may each be configured to determine a merit score for the captured version of image 122 (e.g., an electronic file or other object that represents image 122), referred to as a captured image. In an embodiment, merit determiner 112 may determine a merit score for the captured version of image 122 independently, or based on a first merit score determined for the captured image by merit determiner 108. In embodiments, one or both of merit determiners 108 and 112 may be present.

Policy logic 110, policy logic 114, and policy logic 116 may each be configured to determine an access policy for the captured image based on a determined merit score for the captured image. In embodiments, one or more of policy logic 110, policy logic 114, and policy logic 116 may be present.

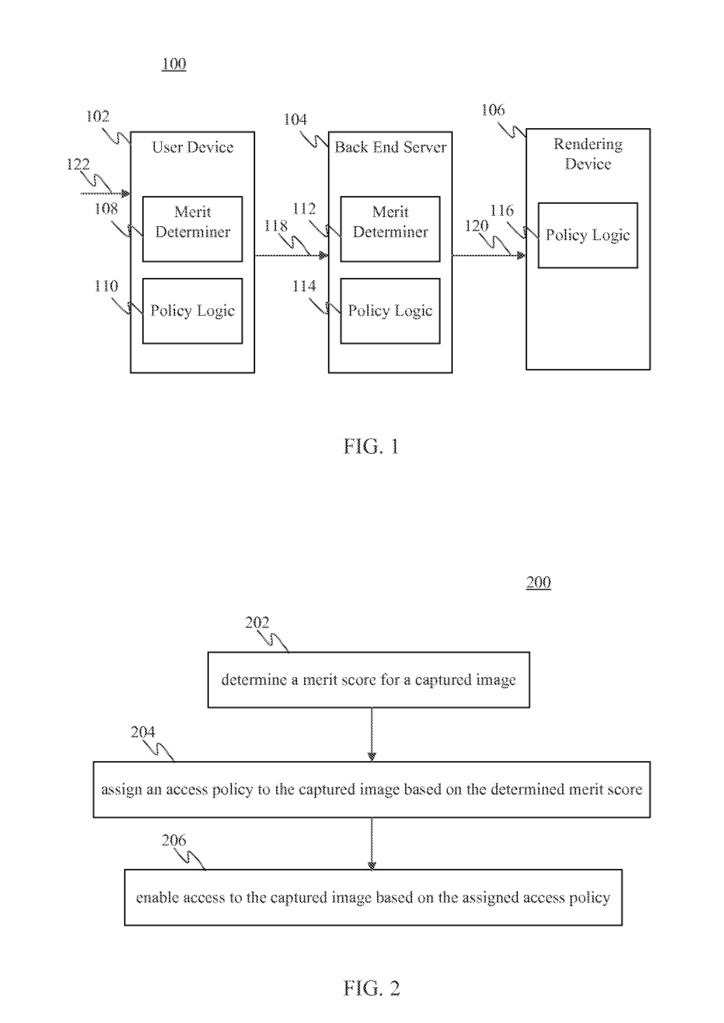

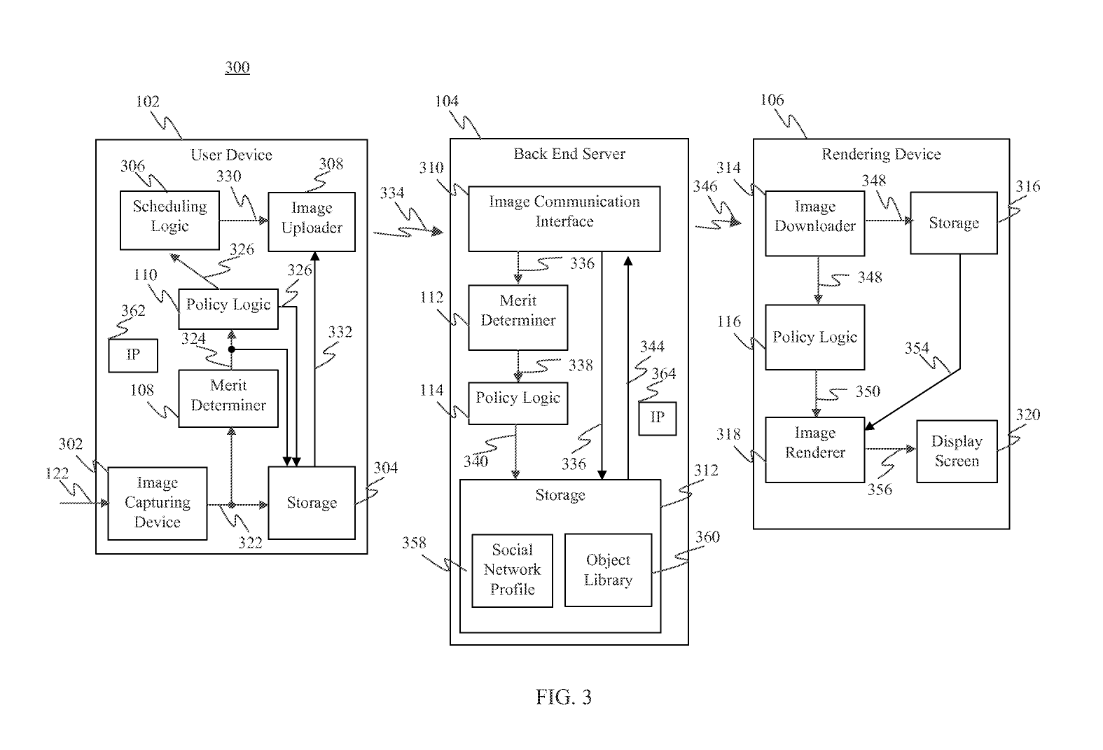

System 100 may operate in various ways. For instance, in an embodiment, one or more components of system 100 may operate according to flowchart 200 in FIG. 2. FIG. 2 shows a flowchart 200 providing a process for enabling access to a captured image, according to an example embodiment. One or more steps of flowchart 200 may be performed by user device 102, back end server 104, and/or rendering device 106. Flowchart 200 is described as follows with respect to FIG. 1. Further structural and operational embodiments will be apparent to persons skilled in the relevant art(s) based on the following description.

Flowchart 200 begins with step 202. In step 202, a merit score is determined for a captured image. One or both of merit determiners 108 and 112 may perform step 202 to determine a merit score for a captured image. The merit score indicates a predicted value of the captured image to a user having an image capturing device used to capture image 122. For instance, merit determiner 108 and/or merit determiner 112 may receive and analyze the captured image (including metadata that may be associated with the captured image) to determine a merit score. As described in further detail below, merit determiner 108 and/or merit determiner 112 may determine characteristics of the captured image, such as color, color uniformity, focus quality, amount of light, whether one or more persons are captured therein, whether one or more objects predetermined as important are captured therein, capture time, capture location, and/or other characteristics that may be used to determine a merit score for the captured image.

In step 204, an access policy is assigned to the captured image based on the determined merit score. In an embodiment, one or more of policy logic 110, 114, and 116 may perform step 204 to determine an access policy for the captured image based on a determined merit score for the captured image. For instance, one or more of policy logic 110, policy logic 114, and/or policy logic 116 may receive a determined merit score for the captured image, and may select an access policy to be assigned to the captured image based on the determined merit score. For instance, a relatively low merit score may indicate that the captured image is not valued by or is not important to the user of user device 102 (e.g., image 122 may have been accidentally captured, such as in the case of a “pocket shot”). In such case, a low level access policy may be assigned to the captured image, which may entail automatic deletion of the captured image, a low upload priority assigned to the captured image, a low resolution (e.g., relatively low number of image pixels) may be applied to the captured image, and/or other low level access policy may be applied. Alternatively, a relatively high merit score may indicate that the captured image is valued by or is important to the user of user device 102. In such case, a high level access policy may be assigned to the captured image, which may entail a high upload priority assigned to the captured image, a high resolution (e.g., relatively high number of image pixels) may be applied to image 122 for upload, and/or other high level access policy may be applied.

In step 206, access to the captured image is enabled based on the assigned access policy. In an embodiment, one or more of user device 102, back end server 104, and/or rendering device 106 may perform step 206 to enable access to the captured image based on the assigned policy.

For instance, based on an access policy assigned by policy logic 110, user device 102 may delete the captured image, may assign a low upload priority to the captured image, may reduce a resolution of the captured image for upload, may assign a high upload priority to the captured image, may select a high resolution version of the captured image for upload, and/or may enable access to the captured image by back end server 104 in another way. As shown in FIG. 1, the captured image may be uploaded to back end server 104 as uploaded image 118. Uploaded image 118 may optionally include the merit score and/or access policy determined for the captured image at user device 102.

As shown in FIG. 1, back end server 104 receives the captured image in uploaded image 118. In an embodiment, back end server 104 may use the merit score and/or access policy determined by user device 102 according to steps 202 and 204. Alternatively, as described above with respect to steps 202 and 204, back end server 104 may determine a merit score and/or access policy for captured image 118, which may be determined based in part on the merit score and/or access policy determined by user device 102 (if they were determined), or may be determined independently (from scratch). Based on the merit score and/or access policy determined at user device 102 (if received with the captured image in uploaded image 118) and/or determined by back end server 104, back end server 104 may delete the captured image, may assign a low download priority to the captured image, may reduce a resolution of the captured image for download, may assign a high download priority to the captured image, may select a high resolution version of the captured image for download, and/or may enable access to the captured image in another way.

As shown in FIG. 1, the captured image may be downloaded to rendering device 106 from back end server 104 as downloaded image 120. For instance, in one embodiment, rendering device 106 may transmit a request to back end server 104 for an image to display, or back end server 104 may push downloaded image 120 to rendering device 106. Downloaded image 120 may optionally include the merit score and/or access policy determined for the captured image at user device 102 and/or at back end server 104.

In an embodiment, rendering device 106 may use the access policy determined by user device 102 and/or back end server 104. Alternatively, as described above with respect to 204, rendering device 106 may determine an access policy for captured image 118, which may be determined based on the merit score and/or access policy determined by user device 102 and/or back end server 104 (if determined), or the access policy may be determined independently (from scratch) by rendering device 106 based on a merit score received with downloaded image 120, or determined at rendering device 106. Based on the merit score and/or access policy determined at one or more of user device 102, back end server 104, and/or rendering device 106, rendering device 106 may delete the captured image, may assign a low display policy to the captured image, may reduce a resolution of the captured image for display and/or storage, may assign a high display priority to the captured image, may select a high resolution version of the captured image for display and/or storage, and/or may enable access to the captured image in another way.

Accordingly, user device 102, back end server 104, and rendering device 106 may be configured in various ways to enable merit scores and access polices to be determined for captured images, and these merit scores and access polices may be used to determine a priority for uploading, downloading, and/or display of the captured images.

Further example embodiments are described in the following subsections. For instance, the next subsection describes example embodiments for intelligent image transfer and display. A subsequent subsection describes example embodiments for determining merit scores, followed by a subsection that describes example embodiments for assigning access policies.

### A. Example Embodiments for Intelligent Image Transfer and Display

FIG. 3 shows a block diagram of a system 300, according to an example embodiment. System 300 is an example implementation of system 100 of FIG. 1. As shown in FIG. 3, system 300 includes user device 102, back end server 104, and rendering device 106. Furthermore, user device 102 includes merit determiner 108, policy logic 110, an image capturing device 302, storage 304, scheduling logic 306, an image uploader 308, and image processor (IP) 362. Back end server 104 includes merit determiner 112, policy logic 114, image communication interface 310, storage 312, and image processor 364. Rendering device 106 includes policy logic 116, an image downloader 314, storage 316, an image renderer 318, and a display screen 320. Each of these features of system 300 are described as follows.

As described above, user device 102 and rendering device 106 may be the same device, or may be separate devices. When user device 102 and rendering device 106 are the same device (i.e., user device 102), policy logic 116 may be included in policy logic 110, storage 316 may be included in storage 304, and user device 102 may include image downloader 314, image renderer 318, and display screen 320.

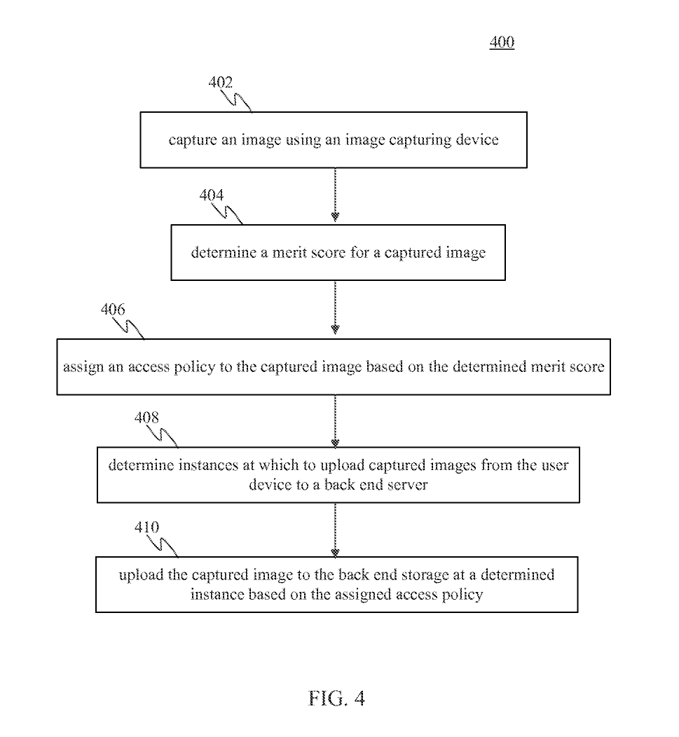

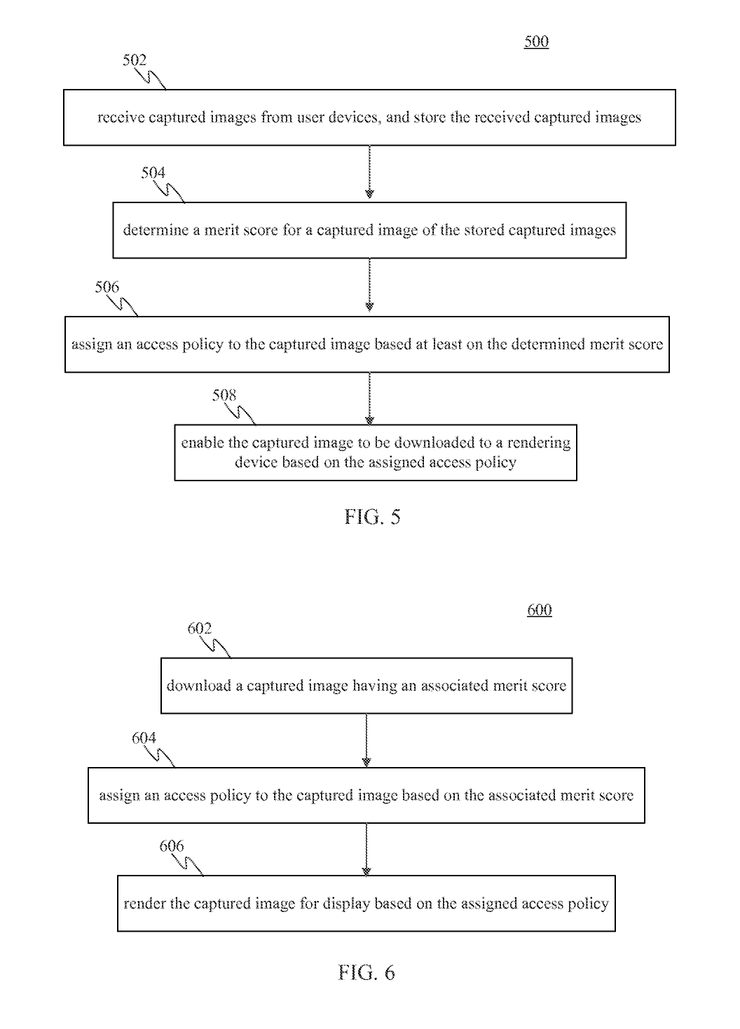

For illustrative purposes, system 300 is described as follows with respect to flowcharts shown in FIGS. 4-6, respectively. FIG. 4 shows a flowchart 400 providing a process in user device 102 to determine a merit score and an access policy for an image captured by user device 102, according to an example embodiment. FIG. 5 shows a flowchart 500 providing a process in back end server 104 to determine a merit score and an access policy for an image captured by a user device, according to an example embodiment. FIG. 6 shows a flowchart 600 providing a process in rendering device 106 to render an image captured by a user device based on an access policy determined for the image, according to an example embodiment. Further structural and operational embodiments will be apparent to persons skilled in the relevant art(s) based on the following description.

Flowchart 400 is described as follows with respect to user device 102 shown in FIG. 3. It is noted that not all steps of flowchart 400 are necessarily performed in all embodiments. Flowchart 400 begins with step 402. In step 402, an image is captured using an image capturing device. For example, as shown in FIG. 3, image capturing device 302 of user device 102 may capture image 122. The user may intentionally interact with user device 102 to cause image capturing device 302 to capture image 122, by pressing a physical or virtual button of user device 102, by speech interaction with user device 102, and/or by interacting with a user interface of user device 102 in another manner. Note that the user may unintentionally interact with a user interface of user device 102 to cause image 122 to be captured. For instance, user device 102 may be in a pocket of the user, and the user interface may be accidentally interacted with in the user's pocket to cause image capturing device 302 to capture image 122. In another example, a child or other person may interact with the user interface of user device 102 without permission of the user to cause image capturing device 302 to capture image 122. Image capturing device 302 may be unintentionally or undesirably interacted with to capture image 122 in other ways.

Image capturing device 302 may be a camera or other device integrated in user device 102 that includes sensors configured to capture images in a digital form. Examples of such sensors include charge coupled devices (CCDs) and CMOS (complementary metal-oxide-semiconductor) sensors. For instance, image capturing device 302 may include a two-dimensional array of sensor elements organized into rows and columns. Such a sensor array may have any number of pixel sensors, including thousands or millions of pixel sensors. Each pixel sensor of the sensor array may be configured to be sensitive to light of a specific color, or color range, such as through the use of color filters. In one example, three types of pixel sensors may be present, including a first set of pixel sensors that are sensitive to the color red, a second set of pixel sensors that are sensitive to green, and a third set of pixel sensors that are sensitive to blue. Other color schemes and/or numbers of types of pixel sensors are also encompassed by embodiments.

As shown in FIG. 3, image capturing device 302 generates a digital image 322 that represents the captured image in a digital form (e.g., pixel data contained in a file or other data structure), and may store digital image 322 in storage 304. Note that each of storage 304, storage 312 (of back end server 104), and storage 316 (of rendering device 106) may include one or more of any type of storage medium/device to store data, including a magnetic disc (e.g., in a hard disk drive), an optical disc (e.g., in an optical disk drive), a memory device such as a RAM (random access memory) device, and/or any other suitable type of physical hardware storage medium/device.

In step 404, a merit score is determined for a captured image. For example, as shown in FIG. 3, merit determiner 108 may receive digital image 322 from image capturing device 302 or may access digital image 322 in storage 304. Merit determiner 108 is configured to determine a merit score for digital image 322 in a manner as described elsewhere herein, including as described above with respect to step 202 of FIG. 2 and/or as described further below. For example, merit determiner 108 may determine characteristics of digital image 322, such as color, color uniformity, focus quality, amount of light, whether one or more persons are captured therein, whether one or more objects predetermined as important are captured therein, capture time, capture location, and/or other characteristics that may be used to determine a merit score for digital image 322.

As shown in FIG. 3, merit determiner 108 generates a merit score 324 for digital image 322. For instance, merit score 324 may indicate a predicted value (importance) of digital image 322 to the user having captured the image with image capturing device 302 of user device 102 (either accidentally or intentionally). Merit score 324 may be indicated in any manner, including as a numerical value (e.g., in a range of −1.0 to 1.0, in a range of 1 to 100, etc.), as an alphanumeric value, a binary value, etc. A higher value for merit score 324 may indicate a higher value of digital image 322 to the user, and a lower value for merit score 324 may indicate a lower value of digital image 322 to the user. As shown in FIG. 3, merit score 324 may be stored in storage 304 in association with digital image 322 (e.g., as metadata, etc.).

In step 406, an access policy is assigned to the captured image based on the determined merit score. For example, as shown in FIG. 3, policy logic 110 may receive merit score 324 from merit determiner 108 (or from storage 304). Policy logic 110 is configured to assign an access policy to digital image 322 in a manner as described elsewhere herein, including as described above with respect to step 204 of FIG. 2 and/or as described further below. For instance, a relatively low merit score may indicate that digital image 322 is not valued by or is not important to the user of user device 102 (e.g., image 122 may have been accidentally captured, such as a “pocket shot”). In such case, a low level access policy may be assigned to digital image. Alternatively, a relatively high merit score may indicate that digital image 322 is valued by or is important to the user of user device 102 (e.g., is a photograph of friends or family of the user, a wedding photo, a photograph of a scenic view, etc.).

As shown in FIG. 3, policy logic 110 generates an access policy indication 326, which indicates the access policy determined for digital image 322 by policy logic 110. Access policy indication 326 may be indicated in any manner, including as a textual description (e.g., “delete,” “low priority upload,” “high priority upload,” “low priority download,” “high priority download,” “low resolution,” “high resolution,” etc.), as a numeric or alphanumeric indicator that maps to a particular access policy, etc. As shown in FIG. 3, access policy indication 326 may be stored in storage 304 in association with digital image 322 (e.g., as metadata, etc.).

Note that if access policy indication 326 indicates “delete”, which indicates digital image 322 is to be deleted, policy logic 110 may provide a delete instruction to storage 304 to delete digital image 322 from storage 304. If access policy indication 326 indicates “low resolution,” meaning that a relatively low resolution version of digital image 322 is to be uploaded (e.g., a low definition version), policy logic 110 may provide a reduce resolution instruction to image processor 362 of user device 102. Image processor 362 may be one or more image processors (e.g., graphics processor(s), etc.) configured to process digital images. The reduce resolution instruction may cause image processor 362 to reduce a resolution of digital image 322 in storage 304 (if a low resolution version is not already available). For instance, image processor 362 may perform pixel averaging to average pixel values of blocks of pixels of digital image 322 to generate a reduced number of pixels in digital image 322. In another example, if access policy indication 326 indicates “high resolution,” meaning that a relatively high resolution version of digital image 322 is to be uploaded (e.g., a high definition (HD) version), policy logic 110 may provide an increase resolution instruction to image processor 362 of user device 102. The increase resolution instruction causes image processor 362 to increase a resolution of digital image 322 in storage 304 (if a high resolution version is not already available). For instance, image processor 362 may perform pixel interpolation to calculate pixel values for new pixels between existing pixels of digital image 322 to generate an increased number of pixels in digital image 322. In either case, access policy indication 326 may cause a default upload image resolution for digital image 322 to potentially be overridden.

In step 408, instances are determined at which to upload captured images from the user device to a back end server. For example, in an embodiment, scheduling logic 306 may be present. When present, scheduling logic 306 may be configured to determine instances (e.g., times) at which captured images are to be automatically uploaded from user device 102 to a server, such as back end server 104.

Scheduling logic 306 may determine one or more instances for uploading images to a server in any suitable manner. For instance, in embodiment, scheduling logic 306 may maintain a regular schedule (one or more time instances) that includes periodic and/or non-periodic times for uploading of one or more images to a server. In an embodiment, scheduling logic 306 may receive and store a schedule received from a server such as back end server 104 that indicates instances at which images are desired to be received by the server. In this manner, images may be automatically uploaded to a server (e.g., without a user manually invoking an upload operation at user device 102). In still another embodiment, scheduling logic 306 may receive requests from back end server 104 for images, and may cause user device 102 to respond to each such request when received. Scheduling logic 306 may determine instances at which images are to be uploaded in further ways, including in any suitable manner. As shown in FIG. 3, scheduling logic 306 may generate an image upload instruction 330 that indicates a current or future time at which an image is to be uploaded to a server.

In an embodiment, scheduling logic 306 may receive access policy 326 from policy logic 110 or storage 304 for digital image 322. Scheduling logic 306 may use access policy 326 to modify an instance at which digital image 322 is to be uploaded to a server. For instance, scheduling logic 306 may use an upload priority determined for digital image 322 to expedite or delay an uploading of digital image 322. If access policy 326 indicates a relatively low upload priority for digital image 322, schedule logic 306 may schedule a time for upload of digital image 322 that is after times at which higher priority images are to be uploaded. If access policy 326 indicates a high upload priority for digital image 322, schedule logic 306 may schedule a time for upload of digital image 322 that is prior to times at which lower priority images are to be uploaded.

In step 410, the captured image is uploaded to the back end server at a determined instance based on the assigned access policy. For example, as shown in FIG. 3, image uploader 308 may be configured to upload images to servers, such as back end server 104. In an embodiment, image uploader 308 may receive image upload instruction 330 that indicates a time at which to upload a particular image. In response to upload instruction 330, image uploader 308 may retrieve the indicated image, such as digital image 322, in storage 304 as retrieved image 332. Retrieved image 332 may optionally include merit score 324 and/or policy usage indication 326 determined for digital image 322. Image uploader 308 may be configured to transmit retrieved image 322 to back end server 104 at the time instance indicated by image upload instruction 330. As shown in FIG. 3, image uploader 308 may transmit retrieved image 332 in an image upload signal 334 over a communication network.

Note that image uploader 308 may include or may access a network interface of user device 102 to transmit and receive communication signals over networks, including transmitting image upload signal 334 (e.g., as a series of data packets, etc.). Example network interfaces are described elsewhere herein.

As shown in FIG. 3, back end server 104 may receive image upload signal 334. As described above, back end server 104 may operate according to flowchart 500 of FIG. 5. Flowchart 500 is described as follows. It is noted that not all steps of flowchart 500 are necessarily performed in all embodiments.

Flowchart 500 begins with step 502. In step 502, captured images are received from user devices, and the received captured images are stored. For example, as shown in FIG. 3, image communication interface 310 of back end server 104 may receive image upload signal 334. As mentioned above, image upload signal 334 may include merit score 324 and/or access policy 326. Image communication interface 310 may include or may access a network interface of back end server 104 to transmit and receive communication signals over networks, including receiving image upload signal 334. Example network interfaces are described elsewhere herein. Image communication interface 310 may store retrieved image 332 included in image upload signal 334 in storage 312 as digital image 336.

In step 504, a merit score is determined for a captured image of the stored captured images. As described above, in an embodiment, merit determiner 112 may be present to determine a merit score for digital image 336. Merit determiner 112 may determine the merit score independently, or may determine the merit score based at least in part based on a merit score determined for digital image 336 by merit determiner 108 at user device 102. Alternatively, merit determiner 112 may not be present in back end server 104, or may not be used, and in such case, step 504 is not performed. When present, merit determiner 112 may be configured to determine a merit score for digital image 336 in a manner as described elsewhere herein, including as described above with respect to step 202 of FIG. 2 and/or as described further below.

Furthermore, when merit determiner 112 determines the merit score for digital image 336 based at least in part on merit score 324 determined by merit determiner 108 of user device 102, merit determiner 112 may independently determine a merit score for digital image 336, and may combine the determined merit score with merit score 324. For instance, in one embodiment, merit determiner 112 may average the value of the merit score it determined with the value of merit score 324 to determine an overall merit score. In this manner, an equal weighting may be given to the merit scores determined by merit determiner 108 and merit determiner 112. In another embodiment, merit determiner 112 may give unequal weightings to the merit scores. For instance, in one embodiment, merit determiner 112 may give a greater weight to the merit score it determined (e.g., a 0.75 scaling factor) and may give a lesser weight to merit score 324 (e.g., a scaling factor of 0.25), and may sum the weighted scores to determine an overall merit score. Alternatively, merit determiner 112 may give a lesser weight to the merit score it determined (e.g., a 0.25 scaling factor) and may give a greater weight to merit score 324 (e.g., a scaling factor of 0.75), and may sum the weighted scores to determine an overall merit score. In further embodiments, merit determiner 112 may be configured to determine the merit score for digital image 336 based at least in part on merit score 324 in other ways.

As shown in FIG. 3, merit determiner 112 generates a merit score 338, which indicates the overall merit score determined for digital image 336 by merit determiner 112.

In step 506, an access policy is assigned to the captured image based at least on the determined merit score. As described above, in an embodiment, policy logic 114 may be present to determine an access policy for digital image 336. Alternatively, policy logic 114 may not be present in back end server 104, or may not be used, and in such case, step 506 is not performed. In such case, the access policy received in image upload signal 334 may be used by back end server 104 for digital image 336.

When present, policy logic 114 may receive merit score 324 received in image upload signal 334, or may receive merit score 338 determined by merit determiner 112. Policy logic 114 is configured to assign an access policy to digital image 336 in a manner as described elsewhere herein, including as described above with respect to step 204 of FIG. 2 and/or as described further below. As shown in FIG. 3, policy logic 114 generates an access policy indication 340, which indicates the access policy determined for digital image 336 by policy logic 114. As shown in FIG. 3, access policy indication 340 (as well as merit score 338) may be stored in storage 312 in association with digital image 336 (e.g., as metadata, etc.).

In step 508, the captured image is enabled to be downloaded to a rendering device based on the assigned access policy. In embodiments, image communication interface 310 may be configured to download images to rendering devices, such as rendering device 106. In an embodiment, image communication interface 310 may include scheduling logic (e.g., similar to scheduling logic 306) that determines a time at which to download a particular image (e.g., in a push model). Alternatively, image communication interface 310 may receive a request for an image from rendering device 106, and may transmit an image to rendering device 106 in response to the request (e.g., a pull model). When an image is to be transmitted, image communication interface 310 may retrieve an image from storage 312, such as digital image 336, as a retrieved image 344. Retrieved image 344 may optionally include merit score 324, merit score 338, policy usage indication 326, and/or policy usage indication 340 determined for digital image 336. Image communication interface 310 may be configured to transmit retrieved image 344 to rendering device 106 at a determined time instance, and/or in response to a request from rendering device 106 for an image. As shown in FIG. 3, communication interface 310 may transmit retrieved image 344 in an image download signal 346 over a communication network.

Note that image communication interface 310 may transmit digital image 336 to rendering device 106 based on the access policy assigned to digital image 336. For instance, image communication interface 310 may use an upload priority determined for digital image 336 to expedite or delay an uploading of digital image 336, as described above. If the access policy indicates “low resolution,” meaning that a relatively low resolution version of digital image 336 is to be downloaded, policy logic 114 may provide a reduce resolution instruction to image processor 364 of back end server 104 (which may be similar to image processor 362 of user device 102), when present. The reduce resolution instruction may cause a resolution of digital image 336 in storage 312 to be reduced by image processor 362 (if a low resolution version is not already available). In another example, if the access policy indicates “high resolution,” meaning that a relatively high resolution version of digital image 336 is to be uploaded, policy logic 114 may provide an increase resolution instruction to image processor 364. The increase resolution instruction may cause a resolution of digital image 336 in storage 312 to be increased by image processor 364 (if a high resolution version is not already available). In any case, the access policy may cause a default download image resolution for digital image 336 to potentially be overridden.

Furthermore, policy logic 114 may provide a delete instruction to storage 312 to delete digital image 336 from storage 304 if dictated by the access policy assigned to digital image 336.

As shown in FIG. 3, rendering device 106 (which may or may not be user device 102) may receive image download signal 346. As described above, rendering device 106 may operate according to flowchart 600 of FIG. 6. Flowchart 600 is described with respect to rendering device 106 shown in FIG. 3. It is noted that not all steps of flowchart 600 are necessarily performed in all embodiments.

Flowchart 600 begins with step 602. In step 602, a captured image having an associated merit score is downloaded. For example, as shown in FIG. 3, image downloader 314 of rendering device 106 may receive image download signal 346. Image download signal 346 may include a merit score and/or access policy determined by back end server 104 and/or by user device 104 for retrieved image 344. Image downloader 314 may include or may access a network interface of rendering device 106 to transmit and receive communication signals over networks, including receiving image download signal 346. Example network interfaces are described elsewhere herein. Image downloader 314 may store retrieved image 344 included in image download signal 346 in storage 316 as digital image 348.

In step 604, an access policy is assigned to the captured image based on the associated merit score. As described above, in an embodiment, policy logic 116 may be present to determine an access policy for digital image 348. Alternatively, policy logic 116 may not be present in rendering device 106, or may not be used, and in such case, step 604 is not performed. In such case, the access policy received in image download signal 346 may be used by rendering device 106 for digital image 348.

When present, policy logic 116 may receive merit score 324 or merit score 338 received in image download signal 346. Policy logic 116 is configured to assign an access policy to digital image 348 in a manner as described elsewhere herein, including as described above with respect to step 204 of FIG. 2 and/or as described further below. As shown in FIG. 3, policy logic 116 generates an access policy indication 350, which indicates the access policy determined for digital image 348 by policy logic 116. As shown in FIG. 3, access policy indication 350 may be stored in storage 316 in association with digital image 348 (e.g., as metadata, etc.).

In step 606, the captured image is rendered for display based on the assigned access policy. In embodiments, image renderer 318 may be configured to render images for display on display screen 320. When an image is to be displayed, according to display logic of image render 318 or other logic rendering device 106, image renderer 318 may retrieve an image from storage 316, such as digital image 348, as a retrieved image 354. Furthermore, as shown in FIG. 3, image renderer 318 receives the access policy assigned to digital image 348 in the form of access policy indication 350 (or an access policy associated with digital image 348 in storage 316). In an embodiment, image renderer 318 may be configured to render display of retrieved image 354 based on the assigned access policy. For instance, a “delete” access policy may cause image renderer 318 to delete digital image 348 in storage 316. A relatively low priority indicated by the assigned access policy (e.g., a low display priority, a low upload or download priority, a low resolution policy, etc.) may cause image renderer 318 to prioritize other images for display (having relatively higher priorities) ahead of retrieved image 354. A relatively high priority indicated by the assigned access policy (e.g., a high display priority, a high upload or download priority, a high resolution policy, etc.) may cause image renderer 318 to prioritize retrieved image 354 for display over other images (having relatively lower priorities).

When retrieved image 354 is to be displayed according to its access policy, image renderer 318 is configured to generate digital image data 356 based on retrieved image 354 that is received by display screen 320. Display screen 320 displays an image corresponding to the captured image based on digital image data 356. The image may be displayed in any application, including being displayed in a browser or other interface. The image may be displayed in a program or application associated with the user, such as being displayed on a social network page associated with the user, being delivered and displayed in a message provided on behalf of the user (e.g., an email, a text message, a “tweet”, etc.), being displayed as a Microsoft Windows® Live Tile (e.g., in the user's mobile device or stationary computing device desktop), being displayed on a blog page of the user, etc. Alternatively, the image may be displayed in an application not associated with the user.

### B. Example Embodiments for Determination of Merit Scores

As described above, merit scores may be automatically determined for captured images. A merit score may indicate the relative importance of the captured image to a user. Such merit scores may be determined in various ways, including according to the techniques described above, as well as according to the techniques described in the present and following subsections.

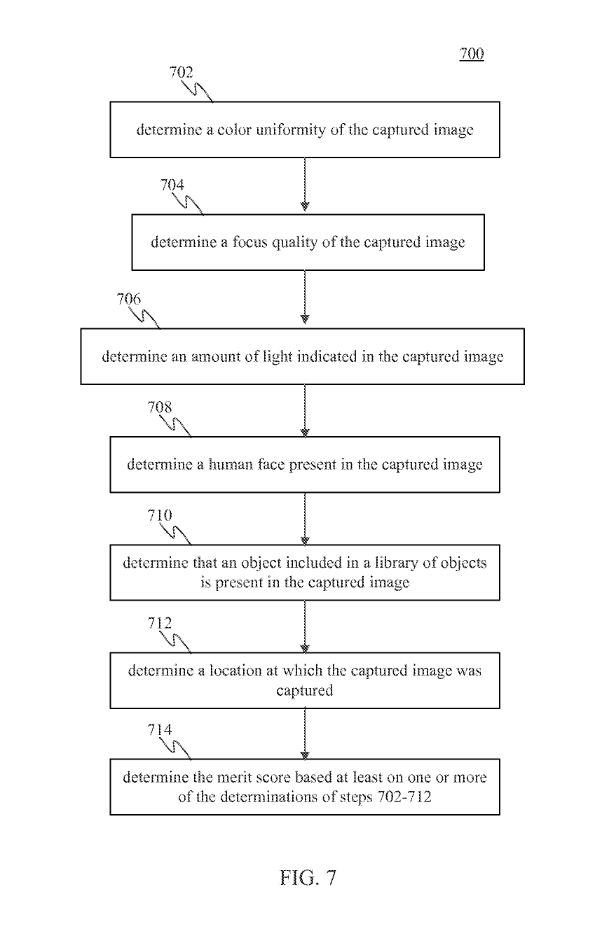

For instance, FIG. 7 shows a flowchart 700 providing a process for determining a merit score for a captured image, according to an example embodiment. In embodiments, flowchart 700 may be performed by each of merit determiners 108 and 112. Note that in a further embodiment, rendering device 106 of FIGS. 1 and 3 may include a merit determiner that may operate according to flowchart 700. Note that any one or more steps of flowchart 700 may be performed in embodiments. Further structural and operational embodiments will be apparent to persons skilled in the relevant art(s) based on the following description.

Flowchart 700 begins with step 702. In step 702, a color uniformity of the captured image is determined. In an embodiment, as described above, a captured image, such as digital image 322, digital image 336, or digital image 348 (FIG. 3) may be analyzed to determine a color uniformity of the captured image. The color uniformity may be indicative of a value of the captured image to the user. For instance, a high color uniformity may be indicative or an accidental photo (e.g., a pocket shot, an accidental touching of the capture button, etc.), an unwanted photo (e.g., taken by a child of the user, etc.), or other relatively featureless photo of relatively low value to the user, such as a photo of a floor, wall, or ceiling, a photo of the ground or sky, etc. A low color uniformity may be indicative of an intentionally captured photo due to an implication that the photo contains a relatively higher level of detail.

In an embodiment, an image processor, such as image processor 362 (user device 102) or image processor 364 (back end server 104), may be configured to perform digital image analysis on the captured image to determine a color uniformity of the captured image in any manner. For instance, the image processor may be configured to determine whether all or a substantially large number of pixels of the captured image have colors within a particular narrow color range. For example, the image processor may determine whether a maximum numerical difference across the pixel values is less than a predetermined threshold difference value. If the maximum numerical difference is less than the predetermined threshold difference value, the image may be considered to have a relatively high color uniformity. If the maximum numerical difference is greater than the predetermined threshold difference value, the image may be considered to have a relatively low color uniformity. Alternatively, the image processor may determine a color uniformity for the captured image in another manner.

In step 704, a focus quality of the captured image is determined. In an embodiment, as described above, a captured image, such as digital image 322, digital image 336, or digital image 348 (FIG. 3) may be analyzed to determine a focus quality of the captured image. The focus quality may be indicative of a value of the captured image to the user. For instance, a low focus quality may be indicative or an accidental photo (e.g., a pocket shot, an accidental touching of the capture button, etc.), an unwanted photo (e.g., taken by a child of the user, a photo where auto-focus did not perform well, etc.), or a photo of otherwise relatively low value to the user. A high focus quality may be indicative of an intentionally captured photo due to an implication that the photo contains a relatively higher level of recognizable detail.

In an embodiment, an image processor, such as image processor 362 (user device 102) or image processor 364 (back end server 104), may be configured to perform digital image analysis on the captured image to determine a focus quality of the captured image in any manner. For instance, the image processor may be configured to determine whether one or more sharp lines are present in the captured image. If at least one sharp line is detected, and furthermore, the greater the number of sharp lines that are detected, the higher the level of focus quality assigned to the captured image. If no (or relatively few) sharp lines are detected, the image may be considered to have a relatively low focus quality. Alternatively, the image processor may determine a focus quality for the captured image in another manner.

In step 706, an amount of light indicated in the captured image is determined. In an embodiment, as described above, a captured image, such as digital image 322, digital image 336, or digital image 348 (FIG. 3) may be analyzed to determine an amount of light in the captured image. The amount of light may be indicative of a value of the captured image to the user. For instance, a low amount of light may be indicative or an accidental photo (e.g., a pocket shot, etc.), an unwanted photo (e.g., a photo taken in poor lighting conditions, etc.), or a photo of otherwise relatively low value to the user. A relatively high amount of light may be indicative of an intentionally captured photo due to an implication that the photo contains a relatively higher level of visible detail.

In an embodiment, an image processor, such as image processor 362 (user device 102) or image processor 364 (back end server 104), may be configured to perform digital image analysis on the captured image to determine an amount of light in the captured image in any manner. For instance, the image processor may be configured to determine whether all or a substantially large number of pixels of the captured image have colors within a particular light color range (e.g., a color range closer to white, more distant from black). For example, the image processor may determine whether an average color of the pixels of the array differs from the color white by less than a predetermined threshold difference value. If the average color of the pixels of the array differs from the color white by less than a predetermined threshold difference value, the image may be considered to have a relatively high amount of light (relatively high brightness). If the average color of the pixels of the array differs from the color white by more than a predetermined threshold difference value, the image may be considered to have a relatively low amount of light (relatively low brightness). Alternatively, the image processor may determine an amount of light apparent in the captured image in another manner.

In step 708, a human face present in the captured image is determined. In an embodiment, as described above, a captured image, such as digital image 322, digital image 336, or digital image 348 (FIG. 3) may be analyzed to whether the captured image includes one or more faces of people. The presence of one or more human faces may be indicative of a value of the captured image to the user. For instance, a lack of human faces may be indicative or an accidental photo (e.g., a pocket shot, an accidental touching of the capture button, etc.), an unwanted photo (e.g., taken by a child of the user, etc.), or a photo of otherwise relatively low value to the user. The presence of one or more faces may be indicative of an intentionally captured photo due to an implication that the photo was taken of people. Furthermore, whether any detected faces are of persons known to the user may also be indicative of a value of the captured image to the user. If one or more faces are detected that are known to the person, this may be indicative of a higher value to the user. If no faces are detected that are known to the person (or a relatively low proportion of the detected faces are known to the user), this may be indicative of a lower value to the user.

In an embodiment, an image processor, such as image processor 362 (user device 102) or image processor 364 (back end server 104), may be configured to perform facial recognition analysis on the captured image to determine the presence of any faces in the captured image. For instance, the image processor may be configured to identify facial features in the captured image by extracting landmarks, and an algorithm may be applied to analyze and determine the relative position, size, and/or shape of the landmarks (e.g., eyes, nose, cheekbones, jaw, etc.), to detect a person's face. In this manner, the presence of one or more faces in the captured image may be determined.

Furthermore, in an embodiment, the image processor may be configured to compare the determined positions, sizes, shapes, etc., of the landmarks to a database of persons to identify the persons. If one or more persons are successfully identified, and the identified persons have a relationship with the user (e.g., family members, friends, co-workers, etc.), this may be further indicative of a value of the captured image to the user. For example, as shown in FIG. 3, storage 312 may store a social network profile 358 for the user, or social network profile 358 may be otherwise retrievable by back end server 104. Social network profile 358 may be a profile of the user with respect to a social network (e.g., Facebook®, Google+™, Twitter™ operated by Twitter, Inc. of San Francisco, Calif., etc.), and may indicate one or more friends, family members, and/or other persons having relationships with the user. If a person identified in the captured image matches a person listed in social network profile 358 of the user, this may indicate a higher value of the captured image to the user.

Alternatively, the image processor may determine the presence of human faces in the captured image, and/or may determine the identity of person(s) having the determined human face(s), in another manner.

In step 710, an object included in a library of objects is determined to be present in the captured image. In an embodiment, as described above, a captured image, such as digital image 322, digital image 336, or digital image 348 (FIG. 3) may be analyzed to whether the captured image includes one or more objects in a library of objects. The presence of one or more such objects may be indicative of a value of the captured image to the user. For instance, a lack of identifiable objects may be indicative or an accidental photo (e.g., a pocket shot, an accidental touching of the capture button, etc.), an unwanted photo (e.g., taken by a child of the user, etc.), or a photo of otherwise relatively low value to the user. The presence of one or more objects that are in a library of objects may be indicative of an intentionally captured photo due to an implication that the photo was taken of something of interest.

In an embodiment, an image processor, such as image processor 362 (user device 102) or image processor 364 (back end server 104), may be configured to perform object recognition analysis on the captured image to determine the presence of any objects of an object library in the captured image. For instance, image processor 364 of FIG. 3 may analyze the captured image for the presence of any objects indicated in an object library 360 stored in storage 312. Object library 360 may store a list of any number of objects, and for each object may indicate one or more structural features of the object (e.g., dimensions, color, size, shape, etc.) that may be used to identify the object in a captured image. The included objects of object library 360 may include general objects (e.g., trees, mountains, other scenic views of objects, animals, appliances, etc.) and/or may include objects that are specific to the user (e.g., a car, house, boat, pet, etc., of the user). The image processor may be configured to identify object features in the captured image by extracting object landmarks, and an algorithm may be applied to analyze and compare the relative position, size, and/or shape of the landmarks to the structure features of the objects in object library 360. Alternatively, the image processor may determine the presence of objects of object library 360 in the captured image in another manner.

Any objects identified in the captured image that match an object stored in object library 360 may be indicative of relatively high value of the captured image to the user. The lack of any objects of object library 360 being identified in the captured image may be indicative of relatively low value of the captured image to the user. The presence of some objects in the captured image may be indicative of relatively low value of the captured image to the user (e.g., a finger on the camera lens, etc.).

Note that although social network profile 358 and object library 360 are shown stored in storage 312 of back end server 104, alternatively or additionally, social network profile 358 and/or object library 360 may be stored in storage 304 of user device 102 and/or storage 316 of rendering device 106 for access by another merit determiner.

In step 712, a location is determined at which the captured image was captured. In an embodiment, as described above, a captured image, such as digital image 322, digital image 336, or digital image 348 (FIG. 3) may be analyzed to determine a location at which the captured image was captured. The capture location may be indicative of a value of the captured image to the user. For instance, capture location inside the user's home or office may be indicative or an accidental photo, an unwanted photo, or a photo of otherwise relatively low value to the user. A capture location that is a vacation location, a tourist location (e.g., a museum, a historical location such as Athens Greece, etc.), or other location where cameras are frequently used, may be indicative of an intentionally captured photo due to an implication that the photo is of something of interest.

In an embodiment, an image processor, such as image processor 362 (user device 102) or image processor 364 (back end server 104), may be configured to analyze metadata associated with the captured image, or otherwise analyze the captured image to determine a capture location for the captured image in any manner. For instance, the metadata associated with the captured image may indicate a location at which the image was captured, as determined by a GPS (global positioning system) module or other location determiner of the user device.

In step 714, the merit score is determined based at least on one or more of the determinations of steps 702-712. In an embodiments, any one or more of steps 702-712 may be performed by a merit determiner in addition or alternatively to other determinations made regarding characteristics of captured image (e.g., location of image capture, time of image capture, etc.). A merit score for the captured image may be generated by the merit determiner based on the determinations. For example, a merit score may be determined based on a single one of the determinations of steps 702-712, or based on a combination of two or more of the determinations of steps 702-712.

For instance, a relatively low color uniformity in a captured image may correspond to a relatively high merit score related to step 702. In one example, in an example merit score scale of 0 to 1, a relatively low color uniformity may correspond to a relatively high merit score for color uniformity of 0.8. Alternatively, a relatively high color uniformity may correspond to a relatively low merit score for color uniformity of 0.3.

In another example, a relatively high focus quality in a captured image may correspond to a relatively high merit score related to step 704. For instance, on the example merit score scale of 0 to 1, a relatively high focus quality may correspond to a relatively high merit score for focus quality of 0.75. Alternatively, a relatively low focus quality may correspond to a relatively low merit score for focus quality of 0.25.

In another example, a relatively high amount of light in a captured image may correspond to a relatively high merit score related to step 706. For instance, on the example merit score scale of 0 to 1, a relatively high amount of light may correspond to a relatively high merit score for amount of light of 0.85. Alternatively, a relatively low amount of light may correspond to a relatively low merit score for amount of light of 0.15.

In another example, a determination of one or more human faces in a captured image may correspond to a relatively high merit score related to step 708. For instance, on the example merit score scale of 0 to 1, a determined human face may correspond to a relatively high merit score for facial presence of 0.7. Alternatively, the lack of any human faces may correspond to a relatively low merit score for facial presence of 0.25.

Furthermore, if one or more determined human faces are determined to be faces of persons having a relationship with the user, this may correspond to an even higher merit score. For instance, a determined human face identified as being of a person having a relationship with the user may correspond to an even higher high merit score for facial presence of 0.9.

In another example, a determination of one or more objects of an object library in a captured image may correspond to a relatively high merit score related to step 710. For instance, on the example merit score scale of 0 to 1, a determined object may correspond to a relatively high merit score for object presence of 0.8. In an embodiment, object library 360 may store a merit score with each object that is to be applied when that object is identified in a captured image. Alternatively, the lack of any objects of the object library may correspond to a relatively low merit score for object presence of 0.25.

Note that all the illustrated merit score scale and the example merit scores provided herein are provided merely for purposes of illustration and are not intended to be limiting. Persons skilled in the relevant art(s) will recognize from the teachings herein that many merit score scales and merit score values and formats may be used in embodiments.

Thus, in embodiments, when a single one of steps 702-712 is performed (or other merit score determination is performed based on an image characteristic), the merit score determined for the single step may be used as the merit score for the captured image in step 714. Alternatively, when multiple steps of steps 702-712 are performed (and/or other merit score determinations performed based on other image characteristics), the merit scores determined for the performed steps may be combined in any manner to be used as the merit score for the captured image in step 714. For example, the individual merit scores may be added together, the merit scores may be averaged, the individual merit scores may be individually scaled and then added together or averaged, and/or the individual merit scores may be combined in any other manner to determine the overall merit score for the captured image.

Note that, as described above, the determinations of flowchart 700 may happen in any combination, and may be performed in one or more of the merit determiners of FIG. 3. For instance, in one embodiment, merit determiner 108 of user device 102 may determine pocket shots (e.g., by performing color uniformity and/or light analysis), merit determiner 112 of back end server 106 (which may have higher processing capability than user device 102) may be used to determine a level of focus of an image, and rendering device 106 (e.g. a photos hub on Microsoft® Windows 8 Live Tiles, etc.) may have knowledge of the user's social graph (e.g., via access to social network profile 358) and may determine which captured images included friends/family, and thus may perform facial analysis. Each device may determine merit appropriately, and may potentially override (e.g., discard or scale down) merit score decisions made by a prior device.

### C. Example Embodiments for Assignment of Access Policies

As described above, access polices may be automatically assigned to captured images. An access policy may indicate how to handle the corresponding captured image, such as whether to automatically upload the captured image to a server, whether to automatically download the captured image to a rendering device, and whether to automatically display the captured image at the rendering device. Access policies may be assigned in various ways, including according to the techniques described above, as well as according to the techniques described in the present and subsequent subsections.

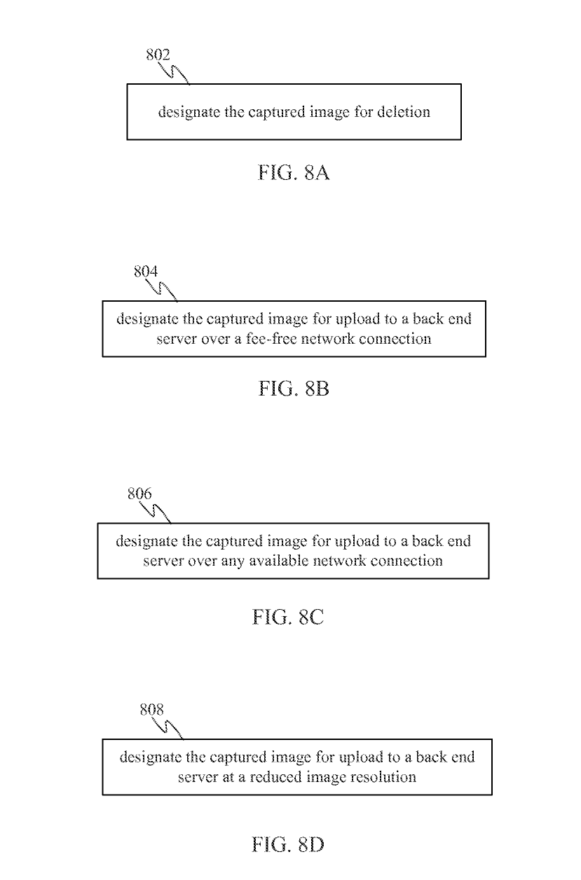

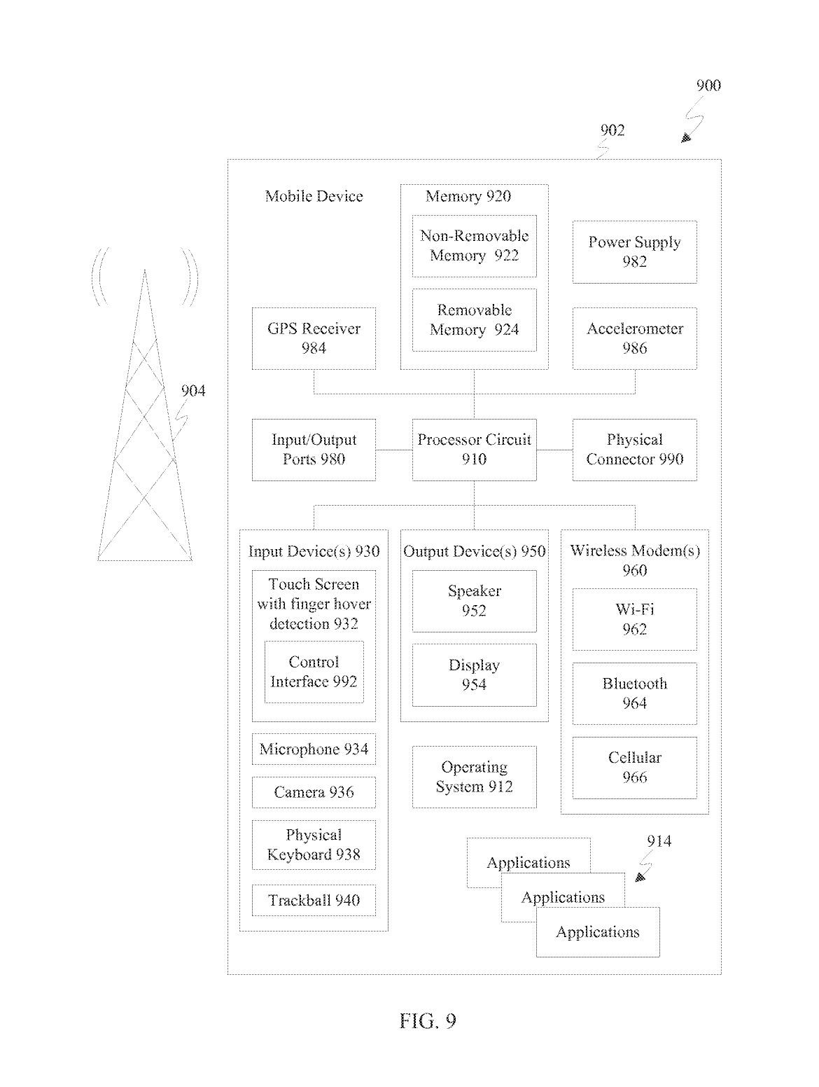

For instance, FIGS. 8A-8D show processes for determining an access policy for a captured image, according to example embodiments. In embodiments, the processes of FIGS. 8A-8D may be performed by policy logic 110, policy logic 114, and/or policy logic 116. Note that one or more of the processes of FIGS. 8A-8D may be performed in combination in some embodiments. Further structural and operational embodiments will be apparent to persons skilled in the relevant art(s) based on the following description.

FIG. 8A shows a process 802. In process 802, the captured image is designated for deletion. For example, in an embodiment, where a captured image has a determined merit score that is relatively very low (e.g., less than 0.1 on a 0 to 1 merit score scale), the access policy assigned to the captured image may be to delete the captured image from storage (e.g., delete digital image 322 from storage 304, delete digital image 336 from storage 312, or delete digital image 348 from storage 316 in FIG. 3). In such case, the estimated value to the user is so low, that the captured image is not worth maintaining. The policy logic or other device component may be configured to perform the deletion in response to the assigned access policy of deletion.

FIG. 8B shows a process 804. In process 804, the captured image is designated for upload to a back end server over a fee-free network connection. In an embodiment, where a captured image has a determined merit score that is relatively low (e.g., less than 0.5 on a 0 to 1 merit score scale), the access policy assigned to the captured image may be to designate the captured image for upload to a server with a low priority. This may meant that, instead of uploading the captured image over any available network connection, the uploader may wait until a no-fee network connection is available (e.g., a home network connection, a free public or work-related Wi-Fi connection, etc.). In this manner, the user does not incur fees for uploading the lesser valued image to the server. Additionally and/or alternatively, a low priority access policy assigned to the captured image may cause the captured image to be uploaded after pending higher priority images are uploaded, and/or after other more important communications are made or completed.

FIG. 8C shows a process 806. In process 806, the captured image is designated for upload to the back end server over any available network connection. In an embodiment, where a captured image has a determined merit score that is relatively high (e.g., greater than 0.5 on a 0 to 1 merit score scale), the access policy assigned to the captured image may be to designate the captured image for upload to a server with a high priority. This may mean that, instead of uploading the captured image over only fee-free network connections, the uploader may upload the image to the server over any available network connection, including network connections for which the user may have to pay a fee (e.g., over a cellular network, a paid Wi-Fi network, etc.). In this manner, the higher valued image is uploaded to the server even if the user is assessed a fee. Additionally and/or alternatively, a high priority access policy assigned to the captured image may cause the captured image to be uploaded before other lower priority images are uploaded, and/or before other more important communications are made or completed.

FIG. 8D shows a process 808. In process 808, the captured image is designed for upload to the back end server at a reduced image resolution. In an embodiment, where a captured image has a determined merit score that is relatively low (e.g., less than 0.5 on a 0 to 1 merit score scale), the access policy assigned to the captured image may be to designate the captured image for upload to a server with a relatively low image resolution. This may mean that, instead of uploading the captured image at a high resolution, the resolution of the image may be reduced, or a low resolution version of the image that is available may be selected, and the reduced/low resolution version of the image may be uploaded to the server. In this manner, less storage may be used to store the lesser valued image, as well as less network bandwidth being used to upload the image to the server.

Additional and/or alternative access policies than those shown in FIGS. 8A-8D may be assigned to captured images, in embodiments, including access polices described elsewhere herein or otherwise known. For instance, for a captured image having a merit score that is relatively very low, the access policy may be to maintain in storage but not upload the captured image, or to store the captured image in a “recycle bin” for later deletion. For a captured image having a merit score that is relatively high, the access policy assigned to the captured image may be to designate the captured image for upload to a server with a relatively high image resolution. Furthermore, the access policies disclosed herein may be applied to downloading captured images to rendering devices, and to managing the display of captured images. For instance, for a captured image having a merit score that is relatively very low, the access policy may be to delete the captured image on the rendering device, to maintain in storage but not display the captured image on the rendering device, or to display the captured image with low frequency, thereby displaying captured images with higher merit scores more frequently. Still further, the access polices disclosed herein may be used in combination with each other. Such access policies may be used to override default access policies for captured images.

### III. Example Mobile and Stationary Device Embodiments

User device 102, back end server 104, rendering device 106, merit determiner 108, policy logic 110, merit determiner 112, policy logic 114, policy logic 116, scheduling logic 306, image uploader 308, image communication interface 310, image downloader 314, image renderer 318, image processor 362, image processor 364, flowchart 200, flowchart 400, flowchart 500, flowchart 600, flowchart 700, and processes 802-808 may be implemented in hardware, or hardware combined with software and/or firmware. For example, merit determiner 108, policy logic 110, merit determiner 112, policy logic 114, policy logic 116, scheduling logic 306 and/or image renderer 318, as well as one or more steps of flowchart 200, flowchart 400, flowchart 500, flowchart 600, flowchart 700, and/or processes 802-808 may be implemented as computer program code/instructions configured to be executed in one or more processors and stored in a computer readable storage medium. Alternatively, user device 102, back end server 104, rendering device 106, merit determiner 108, policy logic 110, merit determiner 112, policy logic 114, policy logic 116, scheduling logic 306, image uploader 308, image communication interface 310, image downloader 314, image renderer 318, image processor 362, and/or image processor 364, as well as one or more steps of flowchart 200, flowchart 400, flowchart 500, flowchart 600, flowchart 700, and/or processes 802-808 may be implemented as hardware logic/electrical circuitry.

For instance, in an embodiment, one or more, in any combination, of merit determiner 108, policy logic 110, merit determiner 112, policy logic 114, policy logic 116, scheduling logic 306, image uploader 308, image communication interface 310, image downloader 314, image renderer 318, image processor 362, image processor 364, flowchart 200, flowchart 400, flowchart 500, flowchart 600, flowchart 700, and/or processes 802-808 may be implemented together in a SoC. The SoC may include an integrated circuit chip that includes one or more of a processor (e.g., a central processing unit (CPU), microcontroller, microprocessor, digital signal processor (DSP), etc.), memory, one or more communication interfaces, and/or further circuits, and may optionally execute received program code and/or include embedded firmware to perform functions.

FIG. 9 shows a block diagram of an exemplary mobile device 900 including a variety of optional hardware and software components, shown generally as components 902. For instance, components 902 of mobile device 900 are examples of components that may be included in user device 102, back end server 104, and/or rendering device 106, in mobile device embodiments. Any number and combination of the features/elements of components 902 may be included in a mobile device embodiment, as well as additional and/or alternative features/elements, as would be known to persons skilled in the relevant art(s). It is noted that any of components 902 can communicate with any other of components 902, although not all connections are shown, for ease of illustration. Mobile device 900 can be any of a variety of mobile devices described or mentioned elsewhere herein or otherwise known (e.g., cell phone, smartphone, handheld computer, Personal Digital Assistant (PDA), etc.) and can allow wireless two-way communications with one or more mobile devices over one or more communications networks 904, such as a cellular or satellite network, or with a local area or wide area network.

The illustrated mobile device 900 can include a controller or processor referred to as processor circuit 910 for performing such tasks as signal coding, image processing, data processing, input/output processing, power control, and/or other functions. Processor circuit 910 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 910 may execute program code stored in a computer readable medium, such as program code of one or more applications 914, operating system 912, any program code stored in memory 920, etc. Operating system 912 can control the allocation and usage of the components 902 and support for one or more application programs 914 (a.k.a. applications, “apps”, etc.). Application programs 914 can include common mobile computing applications (e.g., email applications, calendars, contact managers, web browsers, messaging applications) and any other computing applications (e.g., word processing applications, mapping applications, media player applications).

As illustrated, mobile device 900 can include memory 920. Memory 920 can include non-removable memory 922 and/or removable memory 924. The non-removable memory 922 can include RAM, ROM, flash memory, a hard disk, or other well-known memory storage technologies. The removable memory 924 can include flash memory or a Subscriber Identity Module (SIM) card, which is well known in GSM communication systems, or other well-known memory storage technologies, such as “smart cards.” The memory 920 can be used for storing data and/or code for running the operating system 912 and the applications 914. Example data can include web pages, text, images, sound files, video data, or other data sets to be sent to and/or received from one or more network servers or other devices via one or more wired or wireless networks. Memory 920 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

A number of programs may be stored in memory 920. These programs include operating system 912, one or more application programs 914, and other program modules and program data. Examples of such application programs or program modules may include, for example, computer program logic (e.g., computer program code or instructions) for implementing merit determiner 108, policy logic 110, merit determiner 112, policy logic 114, policy logic 116, scheduling logic 306, image uploader 308, image communication interface 310, image downloader 314, image renderer 318, flowchart 200, flowchart 400, flowchart 500, flowchart 600, flowchart 700, and/or processes 802-808 (including any suitable step of flowcharts 200, 400, 500, 600, and 700), and/or further embodiments described herein.

Mobile device 900 can support one or more input devices 930, such as a touch screen 932, microphone 934, camera 936, physical keyboard 938 and/or trackball 940 and one or more output devices 950, such as a speaker 952 and a display 954. Touch screens, such as touch screen 932, can detect input in different ways. For example, capacitive touch screens detect touch input when an object (e.g., a fingertip) distorts or interrupts an electrical current running across the surface. As another example, touch screens can use optical sensors to detect touch input when beams from the optical sensors are interrupted. Physical contact with the surface of the screen is not necessary for input to be detected by some touch screens. For example, the touch screen 932 may be configured to support finger hover detection using capacitive sensing, as is well understood in the art. Other detection techniques can be used, as already described above, including camera-based detection and ultrasonic-based detection. To implement a finger hover, a user's finger is typically within a predetermined spaced distance above the touch screen, such as between 0.1 to 0.25 inches, or between 0.0.25 inches and 0.05 inches, or between 0.0.5 inches and 0.75 inches or between 0.75 inches and 1 inch, or between 1 inch and 1.5 inches, etc.

The touch screen 932 is shown to include a control interface 992 for illustrative purposes. The control interface 992 is configured to control content associated with a virtual element that is displayed on the touch screen 932. In an example embodiment, the control interface 992 is configured to control content that is provided by one or more of applications 914. For instance, when a user of the mobile device 900 utilizes an application, the control interface 992 may be presented to the user on touch screen 932 to enable the user to access controls that control such content. Presentation of the control interface 992 may be based on (e.g., triggered by) detection of a motion within a designated distance from the touch screen 932 or absence of such motion. Example embodiments for causing a control interface (e.g., control interface 992) to be presented on a touch screen (e.g., touch screen 932) based on a motion or absence thereof are described in greater detail below.

Other possible output devices (not shown) can include piezoelectric or other haptic output devices. Some devices can serve more than one input/output function. For example, touch screen 932 and display 954 can be combined in a single input/output device. The input devices 930 can include a Natural User Interface (NUI). An NUI is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 912 or applications 914 can comprise speech-recognition software as part of a voice control interface that allows a user to operate the device 900 via voice commands. Further, device 900 can comprise input devices and software that allows for user interaction via a user's spatial gestures, such as detecting and interpreting gestures to provide input to a gaming application.

Wireless modem(s) 960 can be coupled to antenna(s) (not shown) and can support two-way communications between processor circuit 910 and external devices, as is well understood in the art. The modem(s) 960 are shown generically and can include a cellular modem 966 for communicating with the mobile communication network 904 and/or other radio-based modems (e.g., Bluetooth 964 and/or Wi-Fi 962). Cellular modem 966 may be configured to enable phone calls (and optionally transmit data) according to any suitable communication standard or technology, such as GSM, 3G, 4G, 5G, etc. At least one of the wireless modem(s) 960 is typically configured for communication with one or more cellular networks, such as a GSM network for data and voice communications within a single cellular network, between cellular networks, or between the mobile device and a public switched telephone network (PSTN).

Mobile device 900 can further include at least one input/output port 980, a power supply 982, a satellite navigation system receiver 984, such as a Global Positioning System (GPS) receiver, an accelerometer 986, and/or a physical connector 990, which can be a USB port, IEEE 1394 (FireWire) port, and/or RS-232 port. The illustrated components 902 are not required or all-inclusive, as any components can be not present and other components can be additionally present as would be recognized by one skilled in the art.

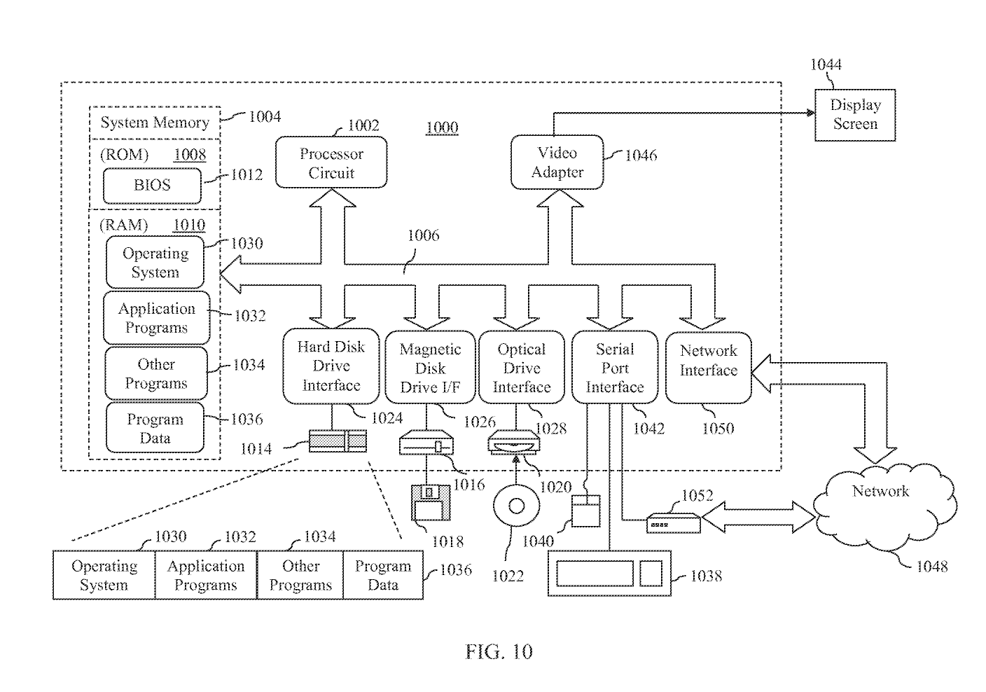

Furthermore, FIG. 10 depicts an exemplary implementation of a computing device 1000 in which embodiments may be implemented. For example, user device 102, back end server 104, and/or rendering device 106 may be implemented in one or more computing devices similar to computing device 1000 in stationary computer embodiments, including one or more features of computing device 1000 and/or alternative features. The description of computing device 1000 provided herein is provided for purposes of illustration, and is not intended to be limiting. Embodiments may be implemented in further types of computer systems, as would be known to persons skilled in the relevant art(s).

As shown in FIG. 10, computing device 1000 includes one or more processors, referred to as processor circuit 1002, a system memory 1004, and a bus 1006 that couples various system components including system memory 1004 to processor circuit 1002. Processor circuit 1002 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 1002 may execute program code stored in a computer readable medium, such as program code of operating system 1030, application programs 1032, other programs 1034, etc. Bus 1006 represents one or more of any of several types of bus structures, including a memory bus or memory controller, a peripheral bus, an accelerated graphics port, and a processor or local bus using any of a variety of bus architectures. System memory 1004 includes read only memory (ROM) 1008 and random access memory (RAM) 1010. A basic input/output system 1012 (BIOS) is stored in ROM 1008.

Computing device 1000 also has one or more of the following drives: a hard disk drive 1014 for reading from and writing to a hard disk, a magnetic disk drive 1016 for reading from or writing to a removable magnetic disk 1018, and an optical disk drive 1020 for reading from or writing to a removable optical disk 1022 such as a CD ROM, DVD ROM, or other optical media. Hard disk drive 1014, magnetic disk drive 1016, and optical disk drive 1020 are connected to bus 1006 by a hard disk drive interface 1024, a magnetic disk drive interface 1026, and an optical drive interface 1028, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules may be stored on the hard disk, magnetic disk, optical disk, ROM, or RAM. These programs include operating system 1030, one or more application programs 1032, other programs 1034, and program data 1036. Application programs 1032 or other programs 1034 may include, for example, computer program logic (e.g., computer program code or instructions) for implementing merit determiner 108, policy logic 110, merit determiner 112, policy logic 114, policy logic 116, scheduling logic 306, image uploader 308, image communication interface 310, image downloader 314, image renderer 318, flowchart 200, flowchart 400, flowchart 500, flowchart 600, flowchart 700, and/or processes 802-808 (including any suitable step of flowcharts 200, 400, 500, 600, and 700), and/or further embodiments described herein.

A user may enter commands and information into the computing device 1000 through input devices such as keyboard 1038 and pointing device 1040. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 1002 through a serial port interface 1042 that is coupled to bus 1006, but may be connected by other interfaces, such as a parallel port, game port, or a universal serial bus (USB).

A display screen 1044 is also connected to bus 306 via an interface, such as a video adapter 1046. Display screen 1044 may be external to, or incorporated in computing device 1000. Display screen 1044 may display information, as well as being a user interface for receiving user commands and/or other information (e.g., by touch, finger gestures, virtual keyboard, etc.). In addition to display screen 1044, computing device 1000 may include other peripheral output devices (not shown) such as speakers and printers.

Computing device 1000 is connected to a network 1048 (e.g., the Internet) through an adaptor or network interface 1050, a modem 1052, or other means for establishing communications over the network. Modem 1052, which may be internal or external, may be connected to bus 1006 via serial port interface 1042, as shown in FIG. 10, or may be connected to bus 1006 using another interface type, including a parallel interface.

As used herein, the terms “computer program medium,” “computer-readable medium,” and “computer-readable storage medium” are used to generally refer to physical hardware media such as the hard disk associated with hard disk drive 1014, removable magnetic disk 1018, removable optical disk 1022, other physical hardware media such as RAMs, ROMs, flash memory cards, digital video disks, zip disks, MEMs, nanotechnology-based storage devices, and further types of physical/tangible hardware storage media (including memory 920 of FIG. 9). Such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media.

As noted above, computer programs and modules (including application programs 1032 and other programs 1034) may be stored on the hard disk, magnetic disk, optical disk, ROM, RAM, or other hardware storage medium. Such computer programs may also be received via network interface 1050, serial port interface 1042, or any other interface type. Such computer programs, when executed or loaded by an application, enable computing device 1000 to implement features of embodiments discussed herein. Accordingly, such computer programs represent controllers of the computing device 1000.

Embodiments are also directed to computer program products comprising computer code or instructions stored on any computer-readable medium. Such computer program products include hard disk drives, optical disk drives, memory device packages, portable memory sticks, memory cards, and other types of physical storage hardware.

### IV. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method, comprising:
determining a merit score for a captured image, the merit score indicating a predicted value of the captured image to a user having an image capturing device used to capture the image;
assigning an access policy to the captured image based on the determined merit score; and
enabling access to the captured image based on the assigned access policy.

2. The method of claim 1, wherein said determining comprises:
determining a color uniformity of the captured image; and
determining the merit score based at least on the determined color uniformity.

3. The method of claim 1, wherein said determining comprises:
determining a focus quality of the captured image; and
determining the merit score based at least on the determined focus quality.

4. The method of claim 1, wherein said determining comprises:
determining an amount of light indicated in the captured image; and
determining the merit score based at least on the determined amount of light.

5. The method of claim 1, wherein said determining comprises:
determining a human face present in the captured image; and
determining the merit score based at least on the determined human face.

6. The method of claim 5, wherein said determining the merit score based at least on the determined human face comprises:
determining that a relationship exists between the user and a person identified as having the human face; and
determining the merit score based at least on the determined relationship.

7. The method of claim 1, wherein said determining comprises:
determining that an object included in a library of objects is present in the captured image; and
determining the merit score based at least on the presence of the object in the captured image.

8. The method of claim 1, wherein said assigning an access policy to the captured image based on the determined merit score comprises at least one of:
designating the captured image for deletion;
designating the captured image for upload to a back end server over a fee-free network connection;
designating the captured image for upload to the back end server over any available network connection; or
designating the captured image for upload to the back end server at a reduced image resolution.

9. A user device, comprising:
a merit determiner configured to determine a merit score for an image captured by the user device due to interaction of a user, the merit score indicating a predicted value of the captured image to the user;
policy logic configured to assign an access policy to the captured image based on the determined merit score;
scheduling logic configured to determine instances at which to upload captured images from the user device to a back end server; and
an image uploader configured to enable the captured image to be uploaded to the back end server based on the assigned access policy and as enabled by the scheduling logic.

10. The user device of claim 9, wherein the merit determiner is configured to determine a color uniformity of the captured image; and to determine the merit score based at least on the determined color uniformity.

11. The user device of claim 9, wherein the merit determiner is configured to determine a focus quality of the captured image, and to determine the merit score based at least on the determined focus quality.

12. The user device of claim 9, wherein the merit determiner is configured to determine an amount of light indicated in the captured image, and to determine the merit score based at least on the determined amount of light.

13. The user device of claim 9, wherein the merit determiner is configured to determine a human face present in the captured image, and determine the merit score based at least on the determined human face.

14. The user device of claim 13, wherein the merit determiner is configured to determine that a relationship exists between the user and a person identified as having the human face, and to determine the merit score based at least on the determined relationship.

15. The user device of claim 9, wherein the merit determiner is configured to determine that an object included in a library of objects is present in the captured image, and determine the merit score based at least on the presence of the object in the captured image.

16. The user device of claim 9, wherein the policy logic is configured to, based on the determined merit score, designate the captured image for deletion, designate the captured image for upload to the back end server over a fee-free network connection, designate the captured image for upload to the back end server over any available network connection, or designate the captured image for upload to the back end server at a reduced image resolution.

17. A server, comprising:
an image communication interface configured to receive captured images from user devices, and to store the received captured images;
a merit determiner configured to determine a merit score for a captured image of the stored captured images, the merit score indicating a predicted value of the captured image to a user associated with a user device from which the captured image was received; and
policy logic configured to assign an access policy to the captured image based at least on the determined merit score;
the image communication interface configured to enable the captured image to be downloaded to a rendering device based on the assigned access policy.

18. The server of claim 17, wherein the merit determiner is configured to determine the merit score for a captured image based at least on a merit score previously determined for the captured image and received with the captured image from the user device.

19. The server of claim 17, wherein the merit determiner is configured to perform at least one of:
determining a color uniformity of the captured image and determining the merit score based at least on the determined color uniformity;
determining a focus quality of the captured image and determining the merit score based at least on the determined focus quality;
determining an amount of light indicated in the captured image and determining the merit score based at least on the determined amount of light;
determining a human face present in the captured image and determining the merit score based on a relationship between the user and a person identified as having the human face determined by accessing a social network of the user; or
determining a location at which the captured image was captured and determining the merit score based at least on the determined color uniformity.

20. The server of claim 17, wherein the merit determiner is configured to determine that an object included in a library of objects is present in the captured image, and determine the merit score based at least on the presence of the object in the captured image.
